(19) United States
(12) Patent Application Publication
(10) Pub. No.: US 2012/0000964 A1
(43) Pub. Date: Jan. 5, 2012

(54) BATTERY TAB JOINTS AND METHODS OF MAKING

(75) Inventors: David R. Sigler, Shelby Township, MI (US); James G. Schroth, Troy, MI (US); Robert B. Ruokolainen, Livonia, MI (US); Blair E. Carlson, Ann Arbor, MI (US); Wayne W. Cai, Troy, MI (US)

(73) Assignee: GM GLOBAL TECHNOLOGY OPERATIONS, INC., Detroit, MI (US)

(21) Appl. No.: 12/828,679

(22) Filed: Jul. 1, 2010

(51) Int. Cl. B23K 1/06; B23K 31/02

(52) U.S. Cl. 228/111.5; 228/101

(57) ABSTRACT

A method of soldering battery cell tabs to a conductor is provided. The battery cell tab and the conductor are made of a material independently selected from aluminum, copper, or nickel-plated copper. The method include preparing an assembly of the battery cell tabs and the conductor with a first joining surface of one battery cell tab face-to-face with a first joining surface of the conductor, at least one joining surface having a layer of solder thereon; pressing the assembly so that the facing joining surfaces engage the solder, and heating the solder to a temperature above a melting temperature of the solder in the absence of a fluxing agent while limiting the displacement of the joining surfaces to a predetermined value; and holding the joining surfaces against each other and solidifying the solder to form a soldered joint between the battery cell tabs and the conductor.

### BACKGROUND OF THE INVENTION

High power lithium batteries for vehicle applications incorporate battery cells that use thin metal sheets as electrode substrates. These electrode sheets incorporate an extension, i.e., tab, which extends outside of the cell pouch and is used to join the electrode sheet to conductors or bus bars made of copper metal or metal alloy or aluminum metal or metal alloy during battery assembly. Two types of tab materials are commonly used in battery construction: aluminum and copper. In some cases, the copper tabs and/or copper conductor may be coated with a thin layer of nickel to enhance corrosion resistance. In some cases, the aluminum tabs and/or aluminum conductor may have a thin anodization layer.

Joining the thin tab materials to the much thicker conductor has been difficult for a number of reasons. First, the stack-ups require the joining of several separate pieces of metal in one operation, e.g., three separate tabs to one conductor. Second, the stack-ups can include a metal combination that is known to form brittle intermetallics, e.g., copper and aluminum. Third, the thickness ratio between the conductor and battery cell tabs can be high, for example at least about 4:1 or more. In addition, joining dissimilar materials can be difficult.

Ultrasonic welding has been used for this application with some success. It enables the joining of dissimilar metals and is capable of joining materials with significant differences in sheet thickness. However, there is considerable difficulty in joining stack-ups that contain more than two sheets because the ultrasonic energy (which involves vibrations parallel to the sheet surface), does not transfer well across multiple sheet-to-sheet interfaces. The top sheet couples well to the ultrasonic energy source because it is in direct contact with the ultrasonic tool or sonotrode; however, sheets located lower in the stack do not receive as much ultrasonic energy, and the joints are not as strong. Another shortcoming of a welded joint is that the joint cannot be easily taken apart nondestructively for replacement or service.

Mechanical fasteners have also been used. Mechanical fasteners, such as screws or clamps, provide a reversible joint. They rely on very low contact resistance to achieve good electrical conductivity. However, contact resistance can degrade over time through buildup of surface contaminants (e.g., oxides), or degradation of the fastener. Furthermore, screws or clamps incur significant mass, cost, and assembly time.

Soldered joints can also be used. However, the use of solders with fluxing agents, particularly for aluminum, can result in the formation of corrosive flux residue that will degrade the surrounding materials or joint over time if not removed by cleaning operations. These operations add cost and, in some cases, may not be possible depending on the assembly sequence.

There remains a need for a process for joining battery cell tabs to conductors or bus bars.

### SUMMARY OF THE INVENTION

The present invention meets this need. A method of soldering at least one battery cell tab to a conductor is provided. The battery cell tab and the conductor are made of a material independently selected from aluminum, aluminum alloys, copper, copper alloys, or nickel-plated copper or copper alloys. The method includes preparing an assembly of the at least one battery cell tab and the conductor with a first joining surface of one battery cell tab face-to-face with a first joining surface of the conductor, at least one joining surface having a layer of solder thereon; pressing the assembly so that the facing joining surfaces engage the solder, and heating the solder to a temperature above a melting temperature of the solder in the absence of a fluxing agent while limiting the displacement of the joining surfaces to a predetermined value; and holding the joining surfaces against each other and solidifying the solder to form a soldered joint between the at least one battery cell tab and the conductor.

### BRIEF DESCRIPTION OF THE DRAWINGS

FIGS. 1A-C are an illustration of one embodiment of a method of joining according to the present invention.

FIGS. 2A-C are an illustration of another embodiment of a method of joining according to the present invention.

FIGS. 3A-C are an illustration of another embodiment of a method of joining according to the present invention.

FIGS. 4A-B are an illustration of another embodiment of a method of joining according to the present invention.

FIGS. 5A-C are an illustration of another embodiment of a method of joining according to the present invention.

### DESCRIPTION OF THE INVENTION

The invention is a method of joining multiple sheet layers fabricated from aluminum or copper. It provides excellent electrical contact, adequate strength, and reversibility. The invention uses heated platens in combination with optional ultrasonic vibrations to solder the thin sheet battery tabs and heavy gauge conductor together. Once the tabs, conductor, and solder alloy are located correctly, heated platens and optionally an ultrasonic transducer (sonotrode) are brought into contact with the stack-up. Preferably, the platens contain a thermocouple for temperature control. Contact between the platens and stack-up causes the solder to melt.

The optional ultrasonic transducers coupled to the conductor and/or platens introduce vibrations into the stack-up that disrupt surface oxides on the substrate materials. This facilitates the formation of intimate metallurgical contact between all layers. Controlling the maximum closure of the platens by using either a servo gun or mechanical stops prevents excessive solder squeeze out. After wetting of the substrates occurs, the heat is turned off to solidify the solder.

In order to prevent excessive heat from being transmitted down the sheet electrode into the battery cell, a second cooled platen can be clamped on the electrode just beneath the heated platens, if desired. This cooled platen also serves the purpose of freezing off/clamping off the molten solder to prevent it from reaching the delicate battery cell. To further prevent molten solder from coming into contact with the battery cell, a gradual increase in the gap between the sheets should slow capillary motion of the solder. In addition, the battery could be inverted, thereby allowing gravity to pull any excess solder metal away from the cell. As an alternative, a “stop-off” coating could be used to coat the sheets beneath the areas to be soldered. Such a coating would decrease the ability to wet the surface so that the solder could not readily flow over areas beyond those intended to be joined.

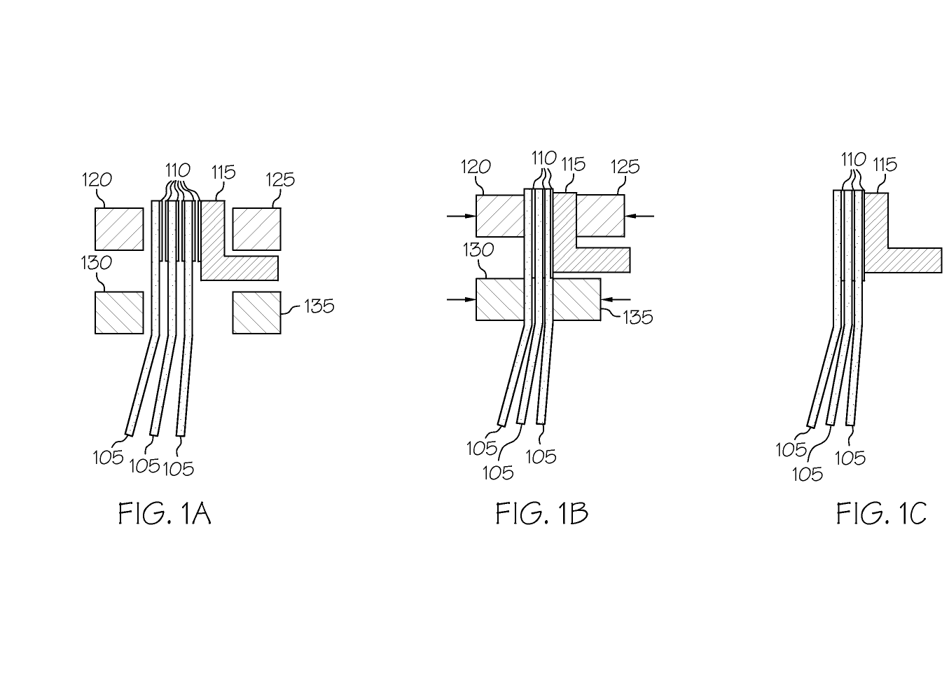

FIGS. 1-5 illustrate various embodiments of the soldering method. The cell pouch is not shown in FIGS. 1-5.

In one embodiment shown in FIGS. 1A-C, there are three battery cell tabs 105 with solder 110 applied to the intended bonding surfaces. The solder 110 can be pre-placed in the joint in various ways, including, but not limited to, pre-coating the substrates in strip or coil form by dip soldering, wave soldering, ultrasonic soldering, or electrodeposition. These methods all ensure that the substrate has been wet by the solder alloy. In addition, because this process does not require pre-wetting of the substrate by the solder alloy (although pre-wetting is permissible), other forms of applying the solder material can also be used, including, but not limited to, powder, wires, or tapes. For example, solder in powder form could be screen printed on the substrates in the desired locations. In addition, the process allows the solder to be selected to match the metal combinations to be joined, e.g., Al to Al, Cu to Cu, Al to Cu, and plated combinations.

Various types of solder can be used, depending on the materials being joined. Suitable solders for all of the substrates include, but are not limited to, pure Zn, Zn—Al alloys, such as those containing up to 10% Al, and Zn—Sn alloys, such as those with up to 90% Sn.

Solder suitable for use with copper include those listed above, as well as Sn—Sb alloys, such as those having about 4.5 to about 5.5% Sb, and Sn—Ag alloys, such as those with about 3.4 to about 5.8% Ag. Sn—Pb and Sn—Cd alloys could also be used for joining Cu to Cu. However, the use of solders containing Pb and/or Cd are not desirable for environmental reasons.

For joining bare aluminum tabs to either bare aluminum, copper, or nickel-plated copper, the solder alloy would typically be a Sn—Zn alloy. The solders can be chosen with a combination of 15 to 40 wt % zinc and 1 to 2 wt % aluminum to reduce the galvanic potential between the solder alloy and aluminum substrate. The high level of Zn mitigates corrosion between the solder and aluminum.

For joining bare copper, or nickel-plated copper, or aluminum substrates, a typical solder alloy would be a Sn—Sb alloy, for example, 95% Sn/5% Sb alloy. The alloy is free of both lead and cadmium. In addition, compared to Pb—Sn solders, it has much higher tensile strength while maintaining good electrical conductivity.

The solder-coated battery cell tabs 105 and a solder-coated copper or aluminum conductor 115 are positioned between platens 120, 125. The platens 120, 125 are heated in the absence of a fluxing agent. The temperature can be controlled with a thermocouple, if desired. The platens will typically be heated to the joining temperature, which is above the solder melting temperature (typically well above the solder melting temperature), before contact in order to reduce the process time. However, this is not required, and they could be heated to the joining temperature after contact. The platens typically use flat faces for maximum heat transfer. Optionally, the platens 120, 125 can each be controlled to a different temperature, which depends on the materials to be joined, the solder alloys, and the material thickness.

The heated platens 120, 125 move together and exert pressure on the battery cell tabs 105 as shown in FIG. 1B. The heat melts the solder 110, which flows downward towards optional cooled platens 130, 135. Optional cooled platens 130, 135 could be clamped on the electrode beneath the heated platens 120, 125 to prevent too much heat from being transmitted down the sheet electrode into the battery cell and damaging the battery cell and to provide rapid solidification of the solder. The cooled platens could contain a system for forced cooling using air, water, or other means to facilitate high volume production.

The joint gap between the platens 120, 125 can be controlled using either servo guns or mechanical stops to prevent excessive squeeze out of the solder, if desired.

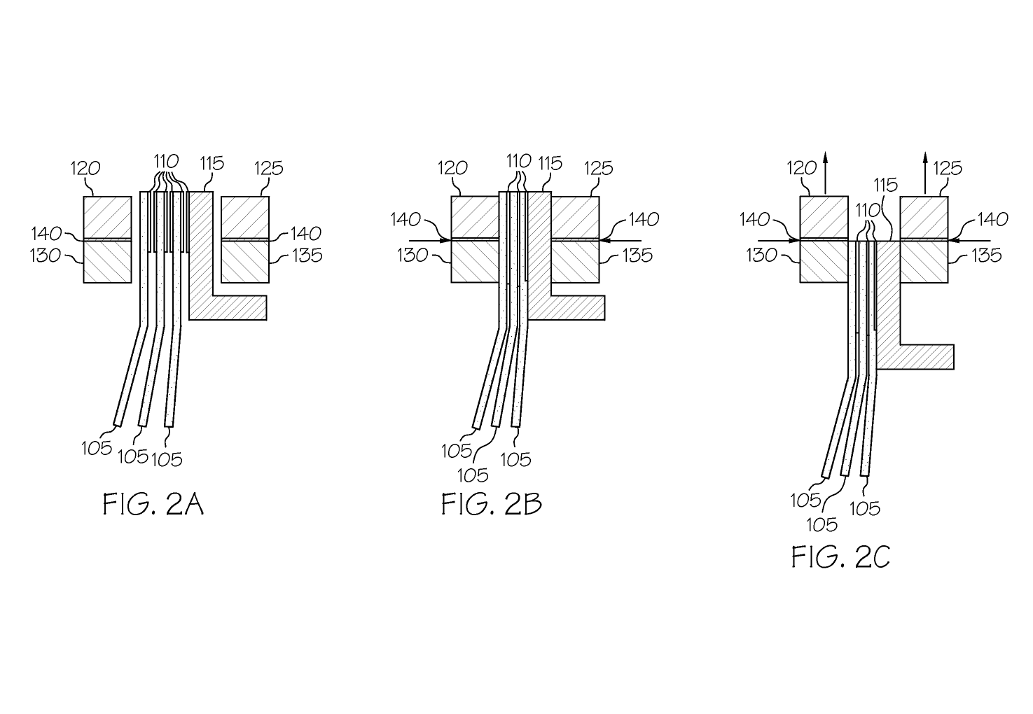

FIG. 2A-C show an alternate process in which the cooled platens 130, 135 are mounted together with the heated platens 120, 125 and separated from them by insulators 140. The solder-coated battery cell tabs 105 are positioned with the conductor 115 between the combined heated platens 120, 125, and cooled platens 130, 135 separated by insulators 140. The heated platens 120, 125 are contacted with the battery cell tabs 105 and conductor 115, melting the solder which flows downward. The platens are then moved upward and the cooled platens 130, 135 contact the joint area to cool and solidify the solder.

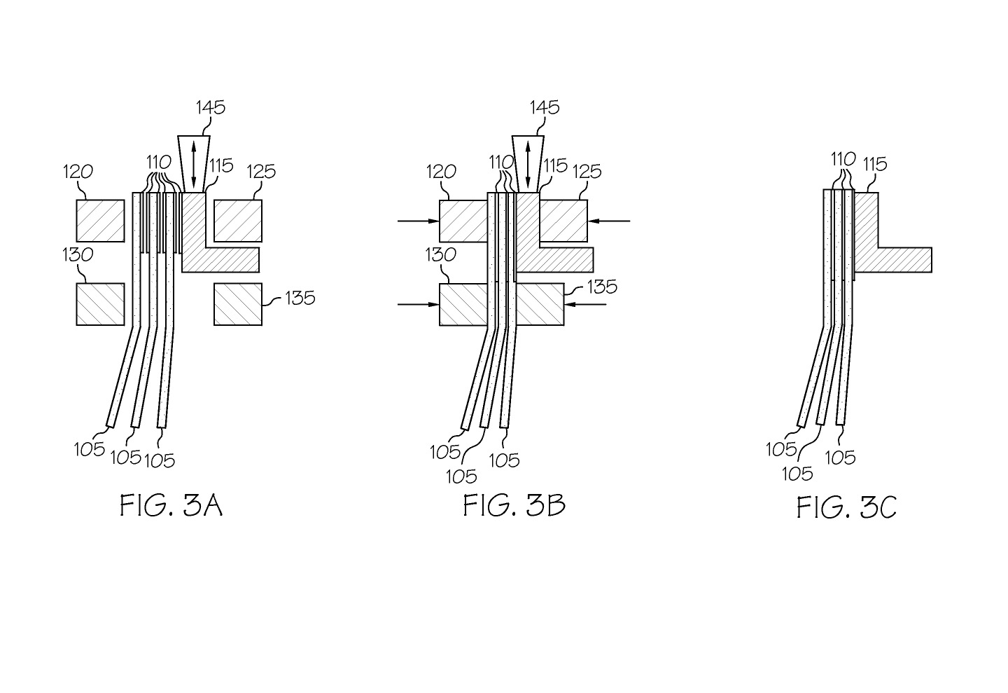

In the embodiment of FIGS. 3A-C, heated platens 120, 125 contact the battery cell tabs 105 and copper conductor 115 stack-up. A sonotrode 145 is placed against the thick copper conductor 115 to provide ultrasonic excitation. During heating, vibrational energy from the sonotrode 145 disrupts the surface oxides and allows the molten solder 110 to establish metallurgical contact. Shutting off the heat source allows the platens to cool and the solder to solidify. In the event of excessive heat flow or solder squeeze out towards the battery cell, cooled platens 130, 135 can be located below the joint area.

For the type of solder joint described above, the joints can be separated easily by providing heat and a mechanism to separate the tab sheet materials. Heating elements similar to those shown in FIG. 1-3 can be used to heat the solder, and thin wires or rods can be used to separate the tabs/conductor once the solder becomes molten. This would leave a solder coating on both the tab materials and conductors. These coatings ensure that the solder had already wet the substrate for re-assembly. The joints would most likely require additional solder material for re-assembly, which could be placed in the joint location as tape, wire, powder, etc. Once the additional solder material was in place, the same heating mechanism could be applied as shown in FIGS. 1-3 to resolder the joint. This allows repair and replacement of individual battery cells, which decreases costs and adds flexibility to the assembly and repair processes.

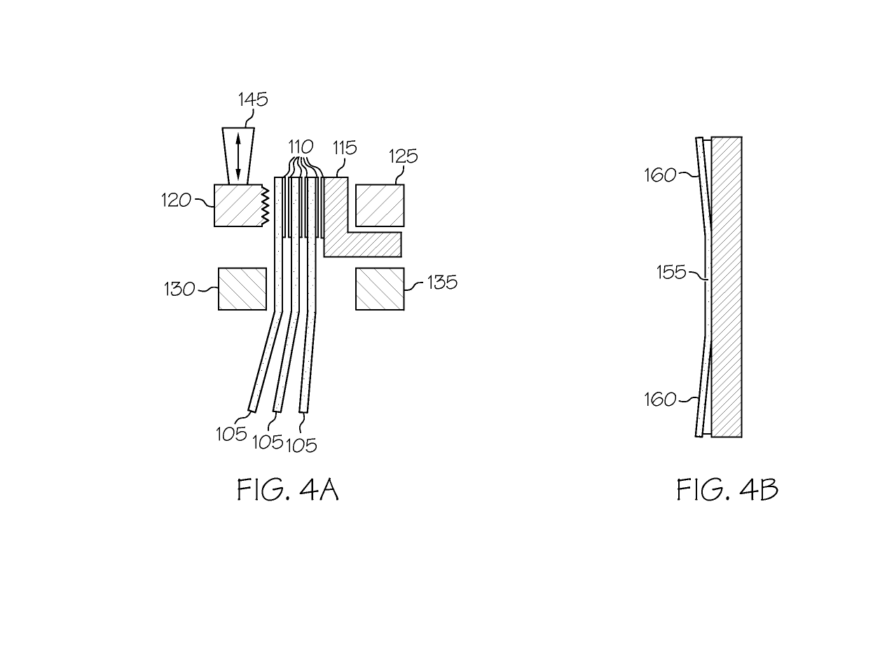

Another embodiment is shown in FIGS. 4A-B. In this case, the platen 120 in contact with the battery cell tab 105 has a sonotrode 145 attached to it. A knurled texture is applied to the platen face to achieve better coupling of the ultrasonic energy between the tool and battery cell tab 105. Under force, heat, and ultrasonic excitation, the knurled platen will locally deform the battery cell tabs. Areas in direct contact with protrusions on the knurled face are pressed together tightly and have the opportunity to form ultrasonic welds. Sheet material surrounding the protrusions suffers deformation that forms gaps between the sheets. Liquid solder fills in the gaps. After solidification the structure consists of small areas of ultrasonically welded material 155 surrounded by larger areas of soldered material 160.

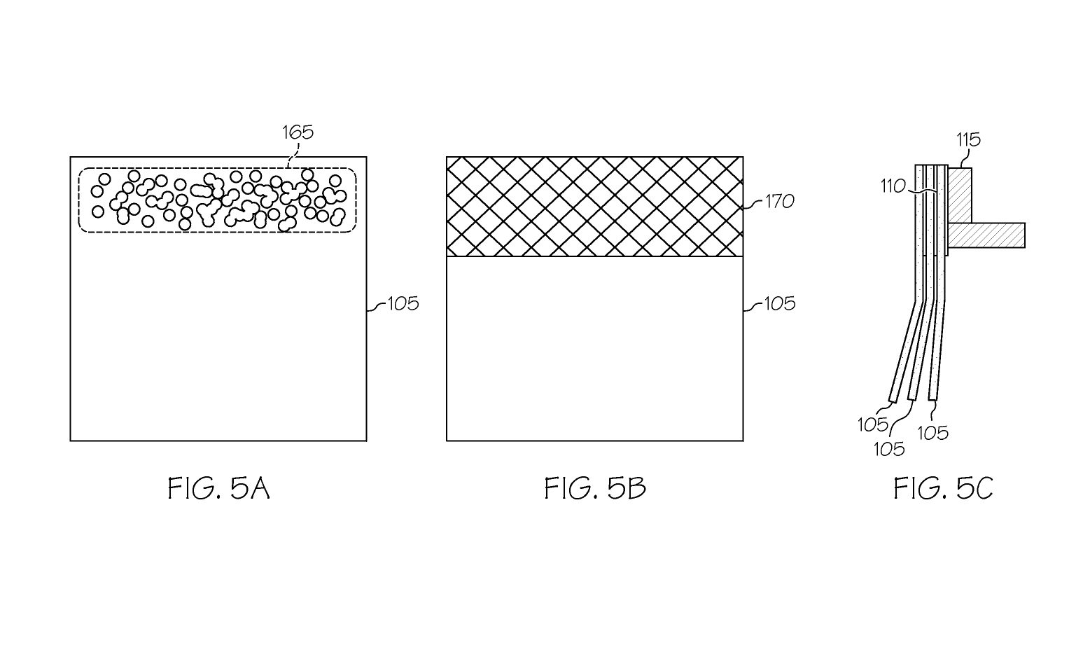

FIG. 5A-C illustrate an alternate embodiment of the battery cell tab. FIGS. 5A-B show battery cell tabs 105 in which there are voids. For example, the voids can be formed by punching holes 165 through the cell tab 105, or a mesh sheet or mesh tab 170 with voids can be used. Other methods of forming voids and other types of voids could also be used. The solder 110 is applied to one of the battery cell tabs 105, for example the battery cell tab in the middle of the stack, as shown in FIG. 5C. When the heated platens are applied to the stack, the solder melts and flows through the voids in the battery cell tabs so that it coats one or more of the other cell tabs and/or the conductor. Depending on the composition of the cell tabs, the conductors, and the solder, the cell tabs can be designed to include voids to permit solder to flow through the cell tabs or not to include voids to prevent the solder from flowing. For example, if the conductor is copper and the cell tabs are aluminum, the cell tab nearest the conductor could be solid so that the Sn—Zn solder between the conductor and the aluminum cell tab does not flow into the Zn—Al solder between the aluminum cell tabs. However, this is not necessary.

Alternatively, a grooved cell tab could be used. The grooves allow extra solder to be deposited to enhance the mechanical strength of the solder joint.

The method allows the joining of several layers of material having different thicknesses, such as those having a thickness ratio between the conductor and tabs of at least about 2:1, at least about 3:1, or at least about 4:1, or at least about 5:1.

It is noted that terms like “preferably,” “commonly,” and “typically” are not utilized herein to limit the scope of the claimed invention or to imply that certain features are critical, essential, or even important to the structure or function of the claimed invention. Rather, these terms are merely intended to highlight alternative or additional features that may or may not be utilized in a particular embodiment of the present invention.

For the purposes of describing and defining the present invention it is noted that the term “device” is utilized herein to represent a combination of components and individual components, regardless of whether the components are combined with other components. For example, a “device” according to the present invention may comprise an electrochemical conversion assembly or fuel cell, a vehicle incorporating an electrochemical conversion assembly according to the present invention, etc.

For the purposes of describing and defining the present invention it is noted that the term “substantially” is utilized herein to represent the inherent degree of uncertainty that may be attributed to any quantitative comparison, value, measurement, or other representation. The term “substantially” is also utilized herein to represent the degree by which a quantitative representation may vary from a stated reference without resulting in a change in the basic function of the subject matter at issue.

Having described the invention in detail and by reference to specific embodiments thereof, it will be apparent that modifications and variations are possible without departing from the scope of the invention defined in the appended claims. More specifically, although some aspects of the present invention are identified herein as preferred or particularly advantageous, it is contemplated that the present invention is not necessarily limited to these preferred aspects of the invention.

What is claimed is:

1. A method of soldering at least one battery cell tab to a conductor, the battery cell tab and the conductor made of a material independently selected from aluminum, aluminum alloys, copper, copper alloys, nickel-plated copper, or nickel-plated copper alloys, the method comprising:
preparing an assembly of the at least one battery cell tab and the conductor with a first joining surface of one battery cell tab face-to-face with a first joining surface of the conductor, at least one joining surface having a layer of solder thereon;
pressing the assembly between a pair of platens so that the facing joining surfaces engage the solder, and heating the solder in the assembly with the platens to a temperature above a melting temperature of the solder in the absence of a fluxing agent while controlling a gap between the pair of platens to limit the displacement of the joining surfaces to a predetermined value; and
holding the joining surfaces against each other and solidifying the solder to form a soldered joint between the at least one battery cell tab and the conductor.

2. The method of claim 1 further comprising applying ultrasonic excitation to the conductor.

3. The method of claim 1 further comprising applying ultrasonic excitation to at least one of the battery cell tabs.

4. The method of claim 3 wherein the ultrasonic excitation is applied to a heated platen having a knurled surface and wherein the soldered joint includes an ultrasonically welded portion.

5. The method of claim 1 further comprising pressing the assembly with a cooled platen.

6. The method of claim 1 wherein all of the joining surfaces have a layer of pre-applied solder thereon.

7. The method of claim 1 wherein at least one battery cell tab has a void or a groove.

8. The method of claim 1 further comprising selecting the solder based on the material of the battery cell tab and the conductor.

9. The method of claim 1 wherein the solder is Zn, Zn—Al alloys, Zn—Sn alloys, Sn—Sb alloys, Sn—Ag alloys, Sn—Pb alloys, or Sn—Cd alloys, or combinations thereof.

10. The method of claim 1 wherein the solder is a Sn—Zn alloy containing Sn, about 15 to about 40 wt % Zn and about 1 to about 2 wt % Al.

11. The method of claim 1 wherein the solder is a Sn—Sb alloy containing about 95 wt % Sn and about 5 wt % Sb.

12. The method of claim 1 wherein there are at least two battery cell tabs, and further comprising preparing the assembly with a second joining surface of the one battery cell tab face-to-face with a first joining surface of a second battery cell tab.

13. The method of claim 1 wherein a ratio of a thickness of the conductor to a thickness of the battery cell tab being at least about 2:1.

14. A method of soldering at least two battery cell tab to a conductor, the battery cell tabs made of a material selected from aluminum, aluminum alloys, copper, copper alloys, nickel-plated copper, or nickel-plated copper alloys, and the conductor made of a material selected from aluminum, aluminum alloys, copper, copper alloys, nickel-plated copper, or nickel-plated copper alloys, the method comprising:
preparing an assembly of the at least two battery cell tabs and the conductor with a first joining surface of one battery cell tab face-to-face with a first joining surface of the conductor, a second joining surface the one battery cell on a side opposite the conductor face-to-face with a first joining surface of a second battery cell tab, at least one joining surface of the battery cell tabs or the conductor having a layer of solder thereon;
pressing the assembly between a pair of platens so that the facing joining surfaces engage the solder, and heating the solder in the assembly with the platens to a temperature above a melting temperature of the solder in the absence of a fluxing agent while controlling a gap between the pair of platens to limit the displacement of the joining surfaces to a predetermined value; and
holding the joining surfaces against each other and solidifying the solder to form a soldered joint between the at least one battery cell tab and the conductor

15. The method of claim 14 further comprising applying ultrasonic excitation to the conductor.

16. The method of claim 14 further comprising applying ultrasonic excitation to at least one of the battery cell tabs.

17. The method of claim 16 wherein the ultrasonic excitation is applied to a heated platen having a knurled surface and wherein the soldered joint includes an ultrasonically welded portion.

18. The method of claim 14 further comprising pressing the assembly with a cooled platen.

19. The method of claim 14 wherein all of the joining surfaces have a layer of pre-applied solder thereon.

20. The method of claim 14 wherein at least one battery cell tab has a void or a groove.
